(19) United States
(12) Patent Application Publication
(10) Pub. No.: US 2012/0096760 A1
(43) Pub. Date: Apr. 26, 2012

(54) MOSQUITO TRAP WITH SOLID STATE LIGHT EMITTING ELEMENTS

(75) Inventor: KUO-CHENG CHANG, Chu-Nan (TW)

(73) Assignee: FOXSEMICON INTEGRATED TECHNOLOGY, INC., Chu-Nan (TW)

(21) Appl. No.: 13/241,068

(22) Filed: Sep. 22, 2011

(30) Foreign Application Priority Data
Oct. 26, 2010 (TW) 099136402

(51) Int. Cl. A01M 1/04; A01M 1/10

(52) U.S. Cl. 43/113

(57) ABSTRACT

A mosquito trap includes a cover for a container, and a plurality of solid state lighting elements. The solid state lighting elements are arranged on the inside of the circular wall of the cover. The solid state lighting elements are electrically connected to a power supply and attract mosquitoes. The cover also has a high-voltage fine-wire grid to electrocute the mosquitoes which go inside the cover due to the attraction of the light generated by the solid state lighting elements.

### BACKGROUND

1. Technical Field

The disclosure relates to mosquito traps, and particularly to a mosquito trap with solid state light emitting elements.

2. Description of the Related Art

The many advantages of light emitting diodes' (LEDs), such as high luminosity, low operational voltage, low power consumption, compatibility with integrated circuits, ease of driving, long term reliability, and environmental friendliness, have promoted their wide use as a light source. Now, light emitting diodes are commonly applied in environmental lighting.

Many mosquito traps includes a plurality of fluorescent tubes. Due to the phototropism of a mosquito, mosquitoes are attracted by the light from a fluorescent tube. Thus, mosquitoes are killed by a high-voltage fine-wire grid, when mosquitoes contact the high-voltage fine-wire grid. However, many mosquito traps use the fluorescent tube which contains an amount of mercury. The fluorescent tube which has an amount of mercury is not good for the environment. Furthermore, because common mosquito trap is not disassemble, the mosquito trap is not easily cleaned. The common mosquito trap is often dirty.

Therefore, it is desirable to provide a mosquito trap with solid state light emitting elements which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present mosquito trap with solid state light emitting elements. Moreover, in the drawings, like reference numerals designate corresponding parts throughout the views.

FIG. 1 is an isometric view of a cover of a mosquito trap with solid state light emitting elements in accordance with a first embodiment.

FIG. 2 is an isometric side view of the mosquito trap with solid state light emitting elements.

### DETAILED DESCRIPTION

Embodiments of a mosquito trap with solid state light emitting elements as disclosed are described in detail with reference to the drawings.

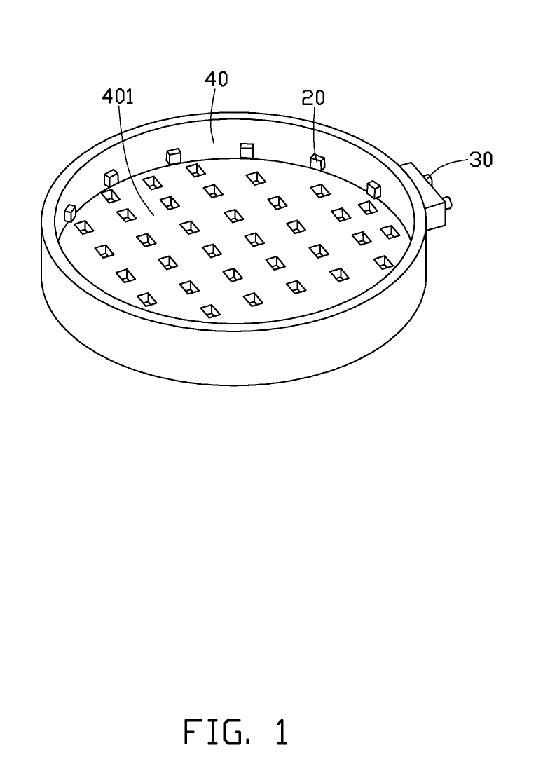

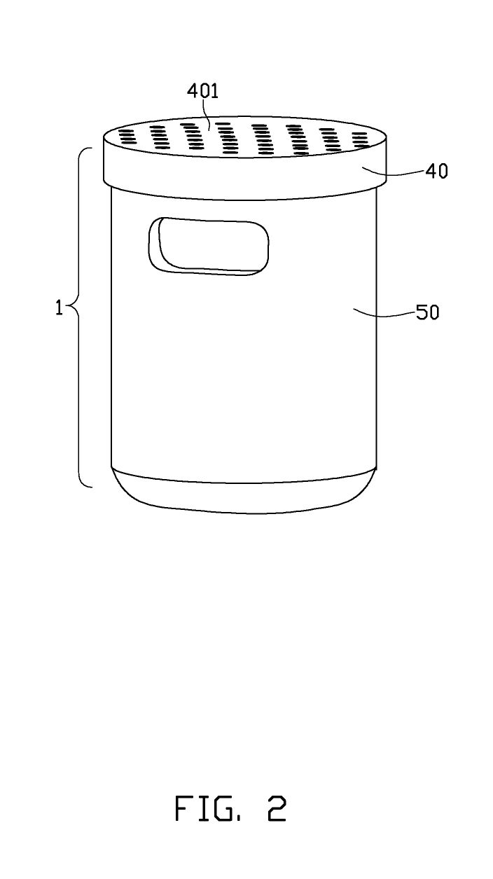

Referring to FIGS. 1 and 2, a mosquito trap with solid state light emitting elements 1 includes a container 50, a cover 40, at least one solid state lighting element 20, a power supply 30, and a high-voltage fine-wire grid 401 arranged inside of the cover 40. The solid state lighting elements 20 are arranged on the inside of the circular wall of the cover 40 and emit a specific wavelength, such as an ultraviolet light with 370 nm wavelength, which is known to have a strong attraction for mosquitoes.

The cover 40 forms a cap or lid on the container 50. The cover 40 is arranged on an opening of the container 50. The power supply 30 is arranged at the outside wall of the cover 40, and all parts of the cover 40 may be made waterproof and shockproof. The container 50 may be used as a container for garbage disposal, and the cover 40 can be lifted and put back easily on the container 50. Therefore, users can easily keep the cover 40 and the container 50 clean. The solid state light emitting elements 20 can be a light emitting diode, an organic light emitting diode, or a laser. The wavelength range of the solid state light emitting elements 20 is from 370 nm to 400 nm.

When the high-voltage fine-wire grid 401 is turned on, mosquitoes are attracted to the light from the solid state light emitting elements 20, and enter the container 50 where they are electrocuted. The dead mosquitoes fall into the container 50. Therefore, because it is convenient to assemble and disassemble the cover 40 and the container 50, it is easy to clean the mosquito trap.

Furthermore, the cover 40 having the solid state light emitting elements 20 and the high-voltage fine-wire grid 401 can be arranged on community garbage containers. Thus, the common trash can be made into mosquito traps by arranging the cover 40 having the solid state light emitting elements 20 and the high-voltage fine-wire grid 401 at the openings of the common trash.

Furthermore, an inner container (not shown) is inside a recession of the container 50. The height of the inner container is less than that of the container 50. The inner container is made of disposable material. When the inner container is dirty, users replace it with a new inner container. Thus, users can easily maintain the cleanliness of the container 50.

Furthermore, the container 50 may have a pedal (not shown). The pedal connects to the cover 40. Users tread on the pedal of the container 50, and the cover 40 opens up, allowing garbage to be thrown in.

Furthermore, the container 50 may be of metal material, polymer material, or thermosetting material. The cover 40 having the solid state light emitting elements 20 and the high-voltage fine-wire grid 401 can operate independently of a container 50 in catching mosquitoes. Furthermore, the power supply 30 can connect to an indoor power supply, or the electrical power of the power supply may be supplied by a battery.

While the disclosure has been described by way of example and in terms of an exemplary embodiment, it is to be understood that the disclosure is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mosquito trap with solid state light emitting elements, comprising: a container, a cover, at least one solid state lighting element, a high-voltage fine-wire grid, and a power supply, the container having a recession, the at least one solid state lighting element being arranged on an inside of a circular wall of the cover, the cover being arranged on an opening of the container, the power supply being arranged on an outside wall of the cover, the at least one solid state lighting element electrically connecting to the power supply, the high-voltage fine-wire grid being arranged inside the cover, and the cover having the high-voltage fine-wire grid connecting electrically to the power supply.

2. The mosquito trap with solid state light emitting elements of claim 1, wherein the container is metal material, polymer material, or thermosetting material.

3. The mosquito trap with solid state light emitting elements of claim 1, wherein the at least one solid state light emitting element can be a light emitting diode, an organic light emitting diode, or a laser.

4. The mosquito trap with solid state light emitting elements of claim 1, wherein an inner container is inside the recession of the container, and a height of the inner container is less than that of the container.

5. The mosquito trap with solid state light emitting elements of claim 1, wherein the power supply electrically connects to an indoor power supply.

6. The mosquito trap with solid state light emitting elements of claim 1, wherein the electrical power of the power supply is supplied by a battery

7. The mosquito trap with solid state light emitting elements of claim 1, wherein a bottom surface of the container has a pedal, the pedal connects to the cover, and the cover opens up when the pedal is depressed.

8. The mosquito trap with solid state light emitting elements of claim 3, wherein a wavelength range of the at least one solid state light emitting element is from 370 nm to 400 nm.
